(19) United States
(12) Patent Application Publication
(10) Pub. No.: US 2006/0193307 A1
(43) Pub. Date: Aug. 31, 2006

(54) Recorded information reproduction device

(75) Inventor: Yoshimi Tomita, Tsurugashima-shi (JP)

Correspondence Address: DRINKER BIDDLE & REATH (DC), 1500 K STREET, N.W., SUITE 1100, WASHINGTON, DC, 20005-1209, US

(73) Assignee: Pioneer Corporation

(21) Appl. No.: 11/352,413

(22) Filed: Feb. 13, 2006

(30) Foreign Application Priority Data
Feb. 14, 2005 (JP) 2005-035710

(51) Int. Cl. H04J 3/06

(52) U.S. Cl. 370/350

(57) ABSTRACT

An apparatus includes an amplitude adjustment section which adjusts the amplitude of a reading sample value sequence in accordance with a gain adjustment signal; a Viterbi decoder which performs Viterbi decoding processing to the amplitude-adjusted reading sample value sequence based on a plurality of estimated values; and an error detection section for generating, as the gain adjustment signal, a difference signal representing the difference between the sample values in the amplitude-adjusted reading sample value sequence and the estimated values.

### BACKGROUND OF THE INVENTION

1. Field of the Invention

The present invention relates to a recorded information reproduction apparatus which reproduces recorded information from a recording medium.

2. Description of the Related Art

As reproduction signal processing for reproducing information data highly reliably from a recording medium on which information data is recorded at a high density, Viterbi decoding processing based on a PRML (partial response maximum likelihood) system is known (See Japanese Patent Application Laid Open No. 2001-189053, for example). In the Viterbi decoding processing, first, a square error value of reading sample values obtained by sampling a reading signal which is read from the recording medium and N (where N is an odd number) estimated values acquired for the reading sample values is found for each of the estimated values.

Thereafter, cumulative addition of the square error values is performed for each of the estimated values and a binary data sequence corresponding to a sequence of estimated values for which the cumulative value is minimum is decoded as a reproduction signal.

However, when asymmetry occurs in the recorded marks (or pits) formed in the recording surface of the recording medium, the waveform of reading signals is sometimes vertically asymmetric with respect to the center of the amplitude of the reading signal which is read from the recording medium. Thus, the square error values which are found for each of the estimated values as mentioned above are inappropriate values and there is the problem that Viterbi decoding processing is no longer executed accurately.

### SUMMARY OF THE INVENTION

The present invention is conceived in view of the above problem and an object of the present invention is to provide a recorded information reproduction apparatus which makes it possible to reproduce information data accurately from the reading signal which is read from the recording medium.

According to one aspect of the present invention, there is provided a recorded information reproduction apparatus which obtains a binary reproduction signal from a reading sample value sequence obtained by sampling a reading signal which is read from a recording medium on which a modulated signal produced by modulating information data is recorded, which comprises an amplitude adjustment section for obtaining an amplitude-adjusted reading sample value sequence by adjusting the amplitude of the reading sample value sequence in accordance with a gain adjustment signal; a Viterbi decoder which obtains the reproduction signal by subjecting the amplitude-adjusted reading sample value sequence to Viterbi decoding processing based on a plurality of estimated values which can be acquired as respective sample values in the reading sample value sequence; and an error detection section for generating, as the gain adjustment signal, a signal representing the difference between the sample values in the amplitude-adjusted reading sample value sequence and the estimated values.

Further, according to another aspect of the present invention, there is provided a recorded information reproduction apparatus which obtains a binary reproduction signal from a reading sample value sequence obtained by sampling a reading signal which is read from a recording medium on which a modulated signal produced by modulating information data is recorded, which comprises a multiplier which generates, as estimated values, respective multiplication results obtained by multiplying each of a plurality of initial estimated values which can be acquired as respective sample values in the reading sample value sequence by the values indicated by the gain adjustment signal; a Viterbi decoder which obtains the reproduction signal by subjecting the reading sample value sequence to Viterbi decoding processing based on the estimated values; and an error detection section for generating, as the gain adjustment signal, a signal representing the difference between the sample values in the reading sample value sequence and the estimated values.

Further, according to another aspect of the present invention, there is provided a recorded information reproduction apparatus which obtains a binary reproduction signal from a reading sample value sequence obtained by sampling a reading signal which is read from a recording medium on which a modulated signal produced by modulating information data is recorded, which comprises an adaptive filter which obtains an adaptive correction reading sample value sequence by subjecting the reading sample value sequence to adaptive filtering processing on the basis of a filter coefficient while changing the filter coefficient to cause convergence to 0 of the error signal; a Viterbi decoder which obtains the reproduction signal by subjecting the reading sample value sequence to Viterbi decoding processing based on a plurality of estimated values which can be acquired as respective sample values in the reading sample value sequence; and an error detection section for generating, as the error signal, a signal representing the difference between the sample values in the reading sample value sequence and the estimated values.

Further, according to another aspect of the present invention, there is provided a recorded information reproduction apparatus which obtains a binary reproduction signal from a reading sample value sequence obtained by sampling a reading signal which is read from a recording medium on which a modulated signal produced by modulating information data is recorded, comprising: a Viterbi decoder which obtains the reproduction signal by subjecting the reading sample value sequence to Viterbi decoding processing based on a plurality of estimated values; and a DC offset adjustment section for adjusting DC offset by entirely level-shifting the signal level of the reading signal on the basis of a differential value between a predetermined sample value in the amplitude-adjusted reading sample value sequence and the estimated values.

When the amplitude of a reading sample value sequence obtained by sampling a reading signal which is read from a recording medium is adjusted in accordance with a gain adjustment signal and Viterbi decoding processing which is based on a plurality of estimated values is performed on the amplitude-adjusted reading sample value sequence, a signal representing the difference between the sample values in the reading sample value sequence and the estimated values is generated as the gain adjustment signal.

### BRIEF DESCRIPTION OF THE DRAWINGS

FIG. 1 shows the configuration of a recorded information reproduction apparatus according to the present invention;

FIGS. 2A-2D show the association between an estimated value Y and an eye pattern based on a reading signal RF which is generated by the recorded information reproduction apparatus shown in FIG. 1, a center-adjusted reading signal RFC, a reading sample value sequence R and an amplitude-adjusted reading sample value sequence RS;

FIG. 3 shows another configuration of a recorded information reproduction apparatus according to the present invention;

FIGS. 4A-4D show the association between the estimated value Y and an eye pattern based on a reading signal RF that is generated by the recorded information reproduction apparatus shown in FIG. 3, the center-adjusted reading signal RFC, the reading sample value sequence R and an offset-corrected reading sample value sequence RR;

FIG. 5 shows another configuration of a recorded information reproduction apparatus according to the present invention;

FIG. 6 shows another configuration of the recorded information reproduction apparatus according to the present invention;

FIG. 7 shows another example of the internal configuration of the amplitude adjustment circuit 8 shown in FIG. 6; and

FIG. 8 serves to illustrate the operation of the recorded information reproduction apparatus shown in FIG. 6.

### DETAILED DESCRIPTION OF THE INVENTION

Embodiments of the present invention will be described hereinbelow.

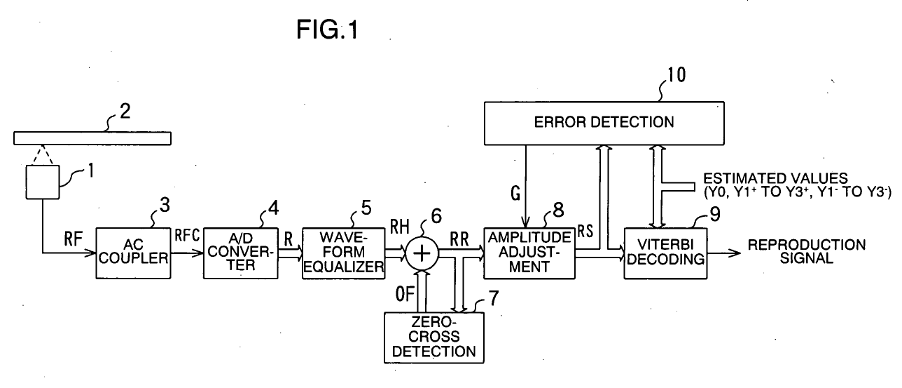

FIG. 1 shows an example of the recorded information reproduction apparatus according to the present invention.

In FIG. 1, a pickup 1 supplies the reading signal RF which is obtained by reading a modulated signal which is recorded on a recordable disk 2 to an AC coupling circuit 3. Further, the modulated signal is a signal obtained by performing modulation to limit the run length on various information data like speech data, picture data or computer data.

The AC coupling circuit 3 obtains the average value of the reading signal RF and supplies the center-adjusted reading signal RFC obtained by shifting the level of the whole reading signal RF so that the average value matches a predetermined center value C0 to an A/D converter 4. Further, the center value C0 corresponds to the center value in the convertible range of the A/D converter 4 (described later) and corresponds to the sample value ‘0’ (described later), for example.

The A/D converter 4 samples the center-adjusted reading signal RFC with timing corresponding to a channel clock signal, converts same into the reading sample value sequence R that consists of an sequence of 8-bit sample values, for example, and supplies the reading sample value sequence R to a waveform equalizer 5. Further, the channel clock signal is a clock signal of a predetermined frequency which is phase-synchronized with the modulated signal.

The waveform equalizer 5 performs processing to increase the values of only the sample values corresponding to a modulated signal of a short run length in the reading sample value sequence R, that is, high-frequency-band enhancement processing, and supplies the high-frequency-band enhancement reading sample value sequence RH thus obtained to an adder 6.

The adder 6 adds an offset correction value OF (described later) to the respective sample values in the high-frequency-band enhancement reading sample value sequence RH and supplies the obtained addition result to a zero crossing detection circuit 7 and amplitude adjustment circuit 8 respectively as an offset-corrected reading sample value sequence RR. The zero crossing detection circuit 7 determines whether one of the two sample values at each end is smaller than the center value C0 and whether the other value is larger than the center value C0 for each of three consecutive sample values in the offset-corrected reading sample value sequence RR. Here, when it is determined that one of the sample values at the two ends in the three consecutive sample values is smaller than the center value C0 and the other sample value is larger than the center value C0, the zero crossing detection circuit 7 supplies the center sample value among the three consecutive sample values to the adder 6 as the offset correction value OF.

As a result of the operation of the adder 6 and zero crossing detection circuit 7, an offset-corrected reading sample value sequence RR that has undergone offset adjustment so that the center of the amplitude of the high-frequency-band enhancement reading sample value sequence RH equals the center value C0 is generated.

The amplitude adjustment circuit 8 supplies an amplitude-adjusted reading sample value sequence RS obtained by adjusting the amplitude value by multiplying the amplitude adjustment value indicated by the gain adjustment signal G (described later) by the respective sample values in the offset-corrected reading sample value sequence RR to a Viterbi decoder 9.

The Viterbi decoder 9 first obtains the square error value of the respective sample values in the amplitude-adjusted reading sample value sequence RS and the estimated values Y0, Y1⁺, Y2⁺, Y3⁺, Y1⁻, Y2⁻, and Y3⁻ for each estimated value.

Further, the estimated value Y0 is the same as the center value C0 and the respective estimated values Y are related in terms of magnitude as follows:
Y3⁻<Y2⁻<Y1⁻<Y0<Y1⁺<Y2⁺<Y3⁺

Thereupon, the estimated values Y0, Y1⁺, Y2⁺, Y3⁺, Y1⁻, Y2⁻, Y3⁻ are ideal values for the reading signal that will be obtained when information reading is performed correctly from the recordable disk 2. Further, the estimated value Y1⁻ or Y1⁺ is an ideal value for the reading signal which is obtained when reading the signal segment having the shortest run length in the modulated signal recorded on the recordable disk 2. On the other hand, the estimated value Y3⁻ or Y3⁺ is an ideal value for the reading signal which is obtained when reading the signal segment having the longest run length in the modulated signal recorded on the recordable disk 2. Further, the estimated value Y0 is the center value of the amplitude of the reading signal.

Thereafter, the Viterbi decoder 9 performs cumulative addition of the square error values for each of the estimated values Y as mentioned earlier and outputs a binary data sequence which corresponds to a sequence of estimated values Y for which the cumulative value is minimum as a reproduction signal.

An error detection circuit 10 first extracts a sample value with the closest value to the estimated value Y1⁺ among the estimated values Y0, Y1⁺, Y2⁺, Y3⁺, Y1⁻, Y2⁻, Y3³¹ respectively and a sample value with the closest value to the estimated value Y⁻ from the amplitude-adjusted reading sample value sequence RS. That is, only the reading sample value obtained during reading of the signal segment with the shortest run length is extracted from the amplitude-adjusted reading sample value sequence RS. Thereafter, the error detection circuit 10 obtains the difference between the estimated value Y1⁺ and the sample value with the closest value to the estimated value Y1⁺ and the difference between the estimated value Y1⁻ and the sample value with the closest value to the estimated value Y1⁻ as the amplitude adjustment values. Further, the error detection circuit 10 supplies a gain adjustment signal G representing this amplitude adjustment value to the amplitude adjustment circuit 8. As a result, the amplitude adjustment circuit 8 adjusts the amplitude of the offset-corrected reading sample value sequence RR so that the sample value with the closest value to the estimated value Y1⁺ in the offset-corrected reading sample value sequence RR is the same value as the estimated value Y1⁺ and so that the sample value with the closest value to the estimated value Y1⁻ is the same value as the estimated value Y1⁻.

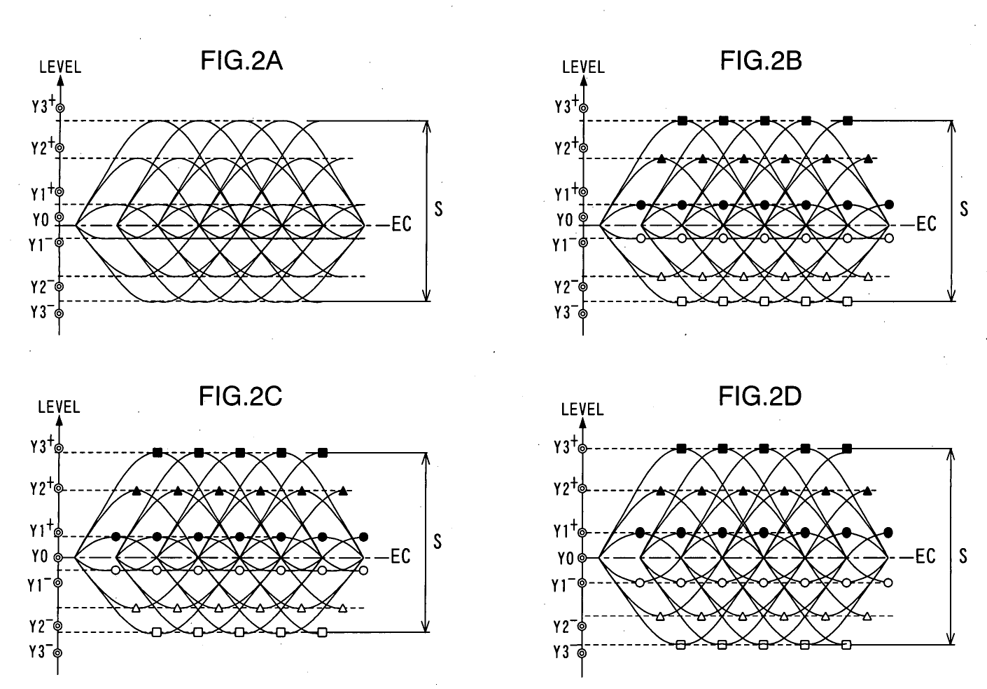

The operation of the recorded information reproduction apparatus shown in FIG. 1 will be described hereinbelow with reference to FIGS. 2A to 2D.

FIG. 2A shows an example of an eye pattern of the reading signal RF which is obtained when asymmetry occurs.

In an example shown in FIG. 2A, the value of the eye center EC (indicated by a dot chain line), that is, the zero crossing point of the reading signal RF is shifted with respect to the center value of the amplitude S of the reading signal RF and also does not match the estimated value Y0 (=center value C0).

Therefore, the recorded information reproduction apparatus shown in FIG. 1 first generates the center-adjusted reading signal RFC which is obtained by shifting the level of the whole of the reading signal RF to establish a match between the value of the reading signal at the eye center EC and the estimated value Y0 (=center value C0) by means of the AC coupling circuit 3. FIG. 2B shows an example of the eye pattern of the center-adjusted reading signal RFC. By sampling the center-adjusted reading signal RFC by means of the A/D converter 4, the reading sample value sequence R consisting of an sequence of sample values as indicated by the x signs, black circle signs and white circle signs (●, ◯), black triangle and white triangle (▴, Δ) or black square and white square sings (▪, □) in FIG. 2C is obtained. For example, the sample values indicated by the circle signs correspond to the values of the reading signal obtained when reading the signal segment with the shortest run length in the modulated signal. Thereupon, each of the sample values indicated by the black circle signs (white circle signs) (●, ◯) does not match the estimated value Y1⁺ (Y1⁻). This is caused by the occurrence of asymmetry, which therefore brings about degradation of the decoding accuracy when Viterbi decoding is performed on the basis of the sample values.

Therefore, the recorded information reproduction apparatus shown in FIG. 1 determines the difference between the nearest neighbor of the eye center EC in the amplitude-adjusted reading sample value sequence RS, that is, a sample value as indicated by the black circle sign (white circle sign) (●, ◯) which has the closest value to the zero crossing point, and the estimated value Y1⁺ (Y1⁻) as the amplitude adjustment value by means of the error detection circuit 10. Further, the amplitude-adjusted reading sample value sequence RS in FIG. 2D, in which the respective sample values in the offset-corrected reading sample value sequence RR are increased or decreased in the same way to the extent of the amplitude adjustment value by means of the amplitude adjustment circuit 8, whereby Viterbi decoding processing is implemented for RS. That is, Viterbi decoding processing is implemented after adjusting the amplitude of the reading sample value sequence in the same way so as to forcibly match the sample values corresponding to the modulated signal of the shortest run length with the estimated value Y1⁺ (Y1⁻).

Accordingly, because the error difference between the estimated value and each of the sample values caused by the asymmetry is removed, even when asymmetry arises in the signal that is recorded on the recordable disk, information data can be repreoduced favorably without bringing about degradation in the decoding function of the Viterbi decoding.

Further, although amplitude adjustment values based on the sample values corresponding to the modulated signal of the shortest run length as indicated by the black circle signs (white circle signs) (●, ◯) were found in the above embodiments, the amplitude adjustment values may be determined on the basis of the sample values as indicated by the black square sign (white square sign)(▪, □) corresponding to the modulated signal of the longest run length. Thereupon, the error detection circuit 10 obtains the amplitude adjustment value corresponding to the difference between the respective sample values indicated by the black square sign (white square sign)(▪, □) in FIG. 2C and the estimated value Y3⁺ (Y3⁻), and generates the gain adjustment signal G indicating the amplitude adjustment value. Further, the amplitude-adjusted reading sample value sequence RS, which is obtained by increasing or decreasing the respective sample values in the offset-corrected reading sample value sequence RR in the same way to the extent of the amplitude modulated values indicated by the gain adjustment signal G, is generated by means of the amplitude adjustment circuit 8, and the amplitude-adjusted reading sample value sequence RS undergoes Viterbi decoding processing.

Further, although the amplitude of the reading sample value sequence may be adjusted on the basis of the difference between the estimated value and the respective sample values in the reading sample value sequence in the above embodiment, the value of the estimated value may be changed on the basis of the difference between the respective sample values and the estimated value.

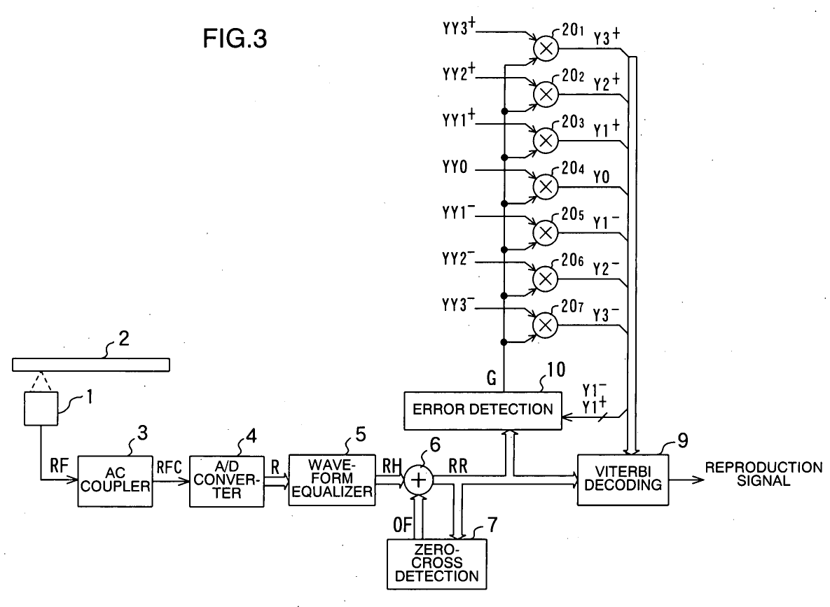

FIG. 3 shows another configuration of the recorded information reproduction apparatus that was conceived in view of this point.

In FIG. 3, the pickup 1 supplies a reading signal RF obtained by reading a modulated signal that is recorded on the recordable disk 2 to the AC coupling circuit 3. This modulated signal is a signal obtained by performing modulation to limit the run length of various information data such as speech data, picture data, or computer data.

The AC coupling circuit 3 obtains the average value of the reading signal RF and supplies the center-adjusted reading signal RFC obtained by shifting the level of the whole reading signal RF so that the average value matches a predetermined center value C0 to an A/D converter 4. Further, the center value C0 corresponds to the center value in the convertible range of the A/D converter 4 (described later) and corresponds to the sample value ‘0’ (described later), for example.

The A/D converter 4 samples the center-adjusted reading signal RFC with timing corresponding to a channel clock signal, converts same into the reading sample value sequence R which consists of an sequence of 8-bit sample values, for example, and supplies the reading sample value sequence R to a waveform equalizer 5. Further, the channel clock signal is a clock signal of a predetermined frequency that is phase-synchronized with the modulated signal.

The waveform equalizer 5 performs processing to increase the values of only the sample values corresponding to a modulated signal of a short run length in the reading sample value sequence R, that is, high-frequency-band enhancement processing, and supplies the high-frequency-band enhancement reading sample value sequence RH thus obtained to an adder 6.

The adder 6 adds an offset correction value OF (described later) to the respective sample values in the high-frequency-band enhancement reading sample value sequence RH and supplies the obtained addition result to the zero crossing detection circuit 7, Viterbi decoder 9, and error detection circuit 10 respectively as an offset-corrected reading sample value sequence RR. The zero crossing detection circuit 7 determines whether one of the two sample values at each end is smaller than the center value C0 and whether the other value is larger than the center value C0 for each of three consecutive sample values in the offset-corrected reading sample value sequence RR. Here, when it is determined that one of the sample values at the two ends in the three consecutive sample values is smaller than the center value C0 and the other sample value is larger than the center value C0, the zero crossing detection circuit 7 supplies the center sample value among the three consecutive sample values to the adder 6 as the offset correction value OF.

As a result of the operation of the adder 6 and zero crossing detection circuit 7, an offset-corrected reading sample value sequence RR that has undergone offset adjustment so that the center of the amplitude of the high-frequency-band enhancement reading sample value sequence RH equals the center value C0 is generated.

A multiplier 20₁ supplies a multiplication result obtained by multiplying an initial estimated value YY3⁺ by the gain adjustment value indicated by the gain adjustment signal G to the Viterbi decoder 9 and the error detection circuit 10 as the estimated value Y3⁺. A multiplier 20₂ supplies a multiplication result obtained by multiplying an initial estimated value YY2⁺ by the gain adjustment value indicated by the gain adjustment signal G to the Viterbi decoder 9 and the error detection circuit 10 as the estimated value Y2⁺. A multiplier 20₃ supplies a multiplication result obtained by multiplying an initial estimated value YY1⁺ by the gain adjustment value indicated by the gain adjustment signal G to the Viterbi decoder 9 and the error detection circuit 10 as the estimated value Y1⁺. A multiplier 20₄ supplies a multiplication result obtained by multiplying an initial estimated value YY0 by the gain adjustment value indicated by the gain adjustment signal G to the Viterbi decoder 9 and the error detection circuit 10 as the estimated value Y0. A multiplier 20₅ supplies a multiplication result obtained by multiplying an initial estimated value YY1⁻ by the gain adjustment value indicated by the gain adjustment signal G to the Viterbi decoder 9 and the error detection circuit 10 as the estimated value Y1⁻. A multiplier 20₆ supplies a multiplication result obtained by multiplying an initial estimated value YY2⁻ by the gain adjustment value indicated by the gain adjustment signal G to the Viterbi decoder 9 and the error detection circuit 10 as the estimated value Y2⁻. A multiplier 20₇ supplies a multiplication result obtained by multiplying an initial estimated value YY3⁻ by the gain adjustment value indicated by the gain adjustment signal G to the Viterbi decoder 9 and the error detection circuit 10 as the estimated value Y3⁻.

Further, the initial estimated value Y0 is the same as the center value C0 and respective initial estimated values YY are related in terms of magnitude as follows:
YY3⁻<YY2⁻<YY1⁻<YY0<YY1⁺<YY2⁺<YY3⁺

Thereupon, the initial estimated values YY0, YY1⁺, YY2⁺, YY3⁺, YY1⁻, YY2⁻, YY3⁻ are ideal values for the reading signal that will be obtained when information reading is performed correctly from the recordable disk 2. Further, the initial estimated value YY1⁻ or YY1⁺ is an ideal value for the reading signal which is obtained when reading the signal segment of the shortest run length in the modulated signal recorded on the recordable disk 2. On the other hand, the initial estimated value YY3⁻ or YY3⁺ is an ideal value for the reading signal which is obtained when reading the signal segment of the longest run length in the modulated signal recorded on the recordable disk 2. Further, the initial estimated value YY0 is the center value of the amplitude of the reading signal.

The Viterbi decoder 9 first obtains a square error value of the respective sample values in the offset-corrected reading sample value sequence RR and each of the estimated values Y0, Y1⁺, Y2⁺, Y3⁺, Y1⁻, Y2⁻, and Y3⁻ which are supplied by the multipliers 20₁ to 20₇ respectively.

Thereafter, the Viterbi decoder 9 performs cumulative addition of the square error values for each of the estimated values Y as mentioned earlier and outputs a binary data sequence which corresponds to a sequence of estimated values Y for which the cumulative value is minimum as a reproduction signal.

An error detection circuit 10 first extracts a sample value with the closest value to the estimated value Y1⁻ among the estimated values Y0, Y1⁺, Y2⁺, Y3⁺, Y1⁻, Y2⁻, Y3⁻ respectively and a sample value with the closest value to the estimated value Y⁻ from the offset-corrected reading sample value sequence RR. That is, only the reading sample value obtained during reading of the signal segment of the shortest run length is extracted from the amplitude-adjusted reading sample value sequence RS. Thereafter, the error detection circuit 10 obtains the difference between the estimated value Y1⁺ and the sample value with the closest value to the estimated value Y1⁺ and the difference between the estimated value Y1⁻ and the sample value with the closest value to the estimated value Y1⁻ as the gain adjustment values. Further, the error detection circuit 10 supplies a gain adjustment signal G representing this gain adjustment value to the multipliers 20₁ to 20₇.

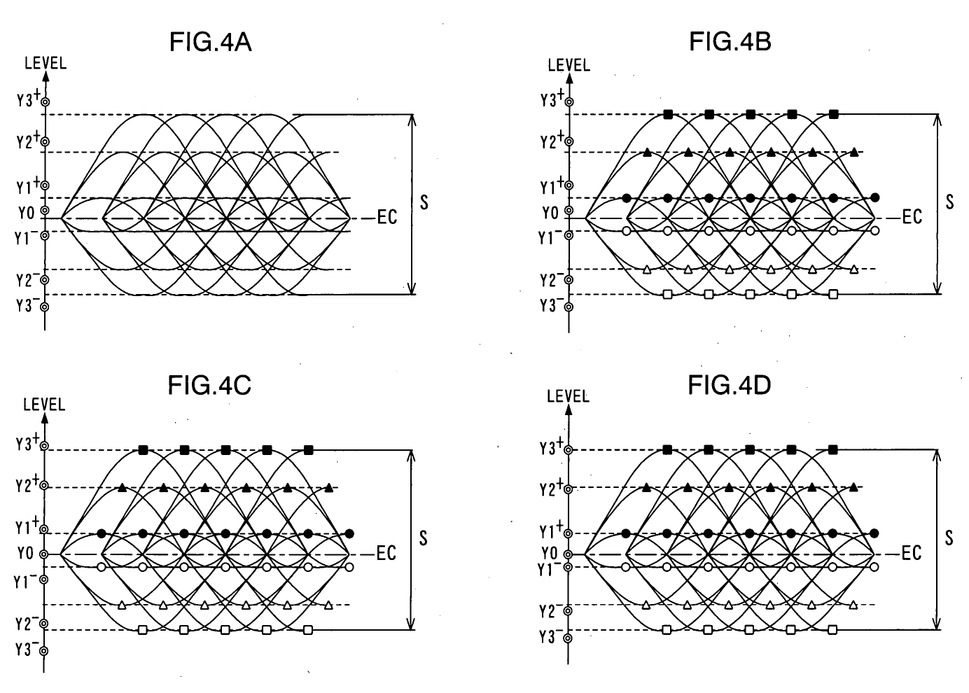

The operation of the recorded information reproduction apparatus shown in FIG. 3 will be described hereinbelow with reference to FIGS. 4A to 4D.

FIG. 4A shows an example of an eye pattern of the reading signal RF which is obtained when asymmetry occurs.

In an example shown in FIG. 4A, the value of the eye center EC (indicated by a dot chain line), that is, the zero crossing point of the reading signal RF is shifted with respect to the center value of the amplitude S of the reading signal RF and also does not match the estimated value Y0 (=center value C0).

Therefore, the recorded information reproduction apparatus shown in FIG. 3 first generates the center-adjusted reading signal RFC obtained by shifting the level of the whole of the reading signal RF to establish a match between the value of the reading signal at the eye center EC and the estimated value Y0 (=center value C0) by means of the AC coupling circuit 3. FIG. 4B shows an example of the eye pattern of the center-adjusted reading signal RFC. By sampling the center-adjusted reading signal RFC by means of the A/D converter 4, the reading sample value sequence R consisting of an sequence of sample values as indicated by the x signs, black circle signs and white circle signs (●, ◯), black triangle signs and white triangle signs (▴, Δ) or black square signs and white square signs (▪, □) in FIG. 4C is obtained. For example, the sample values indicated by the circle signs correspond to the values of the reading signal obtained when reading the signal segment of the shortest run length in the modulated signal. Thereupon, each of the sample values indicated by the black circle signs (white circle signs) (●, ◯) does not match the estimated value Y1⁺ (Y1⁻). This is caused by the occurrence of asymmetry, which therefore brings about degradation in the decoding accuracy when Viterbi decoding is performed on the basis of the sample values.

Therefore, the recorded information reproduction apparatus shown in FIG. 3 first determines the difference between the nearest neighbor of the eye center EC in the offset-corrected reading sample value sequence RR, that is, the sample value as indicated by the black circle sign (white circle sign) (●, ◯) that has the closest value to the zero crossing point, and the estimated value Y1⁺ (Y1⁻) by means of the error detection circuit 10. That is, the difference between the sample values corresponding to the modulated signal of the shortest run length and the estimated value Y1⁺ (Y1⁻) are found. Further, the values of the estimated values Y0, Y1⁺, Y2⁺, Y3⁺, Y1⁻, Y2⁻, and Y3⁻ are increased or decreased in the same way to the extent of the this difference by the multipliers 20₁ to 20₇. As a result of this estimated-value adjustment operation, as shown in FIG. 4D, the sample values as indicated by the black circle signs (white circle signs) (●, ◯) in the offset-corrected reading sample value sequence RR are forcibly made to match the estimated value Y1⁺ (Y1⁻).

Accordingly, because the error difference between the estimated value and each of the sample values caused by the asymmetry is removed, even when asymmetry arises in the signal that is recorded on the recordable disk, for example, information data can be reproduced favorably without bringing about degradation in the decoding function of the Viterbi decoding.

Furthermore, in the recorded information reproduction apparatus shown in FIG. 1, although the amplitude of the offset-corrected reading sample value sequence RR is adjusted by the amplitude adjustment circuit 8, an adaptive filter may also be used instead of the amplitude adjustment circuit 8.

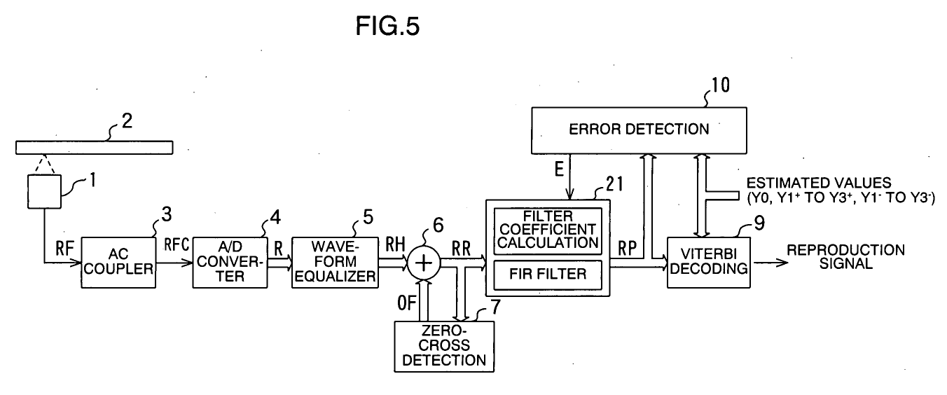

FIG. 5 shows another configuration of the recorded information reproduction apparatus according to the present invention that was conceived in view of this point.

In FIG. 5, the pickup 1 supplies a reading signal RF obtained by reading a modulated signal that is recorded on the recordable disk 2 to the AC coupling circuit 3. This modulated signal is a signal obtained by performing modulation to limit the run length of various information data such as speech data, picture data, or computer data.

The AC coupling circuit 3 obtains the average value of the reading signal RF and supplies the center-adjusted reading signal RFC obtained by shifting the level of the whole reading signal RF so that the average value matches a predetermined center value C0 to an A/D converter 4. Further, the center value C0 corresponds to the center value in the convertible range of the A/D converter 4 (described later) and corresponds to the sample value ‘0’ (described later), for example.

The A/D converter 4 samples the center-adjusted reading signal RFC with timing corresponding to a channel clock signal, converts same into the reading sample value sequence R that consists of an sequence of 8-bit sample values, for example, and supplies the reading sample value sequence R to an adder 6.

The adder 6 adds an offset correction value OF (described later) to the respective sample values in the high-frequency-band enhancement reading sample value sequence RH and supplies the obtained addition result to the zero crossing detection circuit 7 and an adaptive filter 21 respectively as an offset-corrected reading sample value sequence RR. The zero crossing detection circuit 7 determines whether one of the two sample values at each end is smaller than the center value C0 and whether the other value is larger than the center value C0 for each of three consecutive sample values in the offset-corrected reading sample value sequence RR. Here, when it is determined that one of the sample values at the two ends in the three consecutive sample values is smaller than the center value C0 and the other sample value is larger than the center value C0, the zero crossing detection circuit 7 supplies the center sample value among the three consecutive sample values to the adder 6 as the offset correction value OF.

As a result of the operation of the adder 6 and zero crossing detection circuit 7, an offset-corrected reading sample value sequence RR that has undergone offset adjustment so that the center of the amplitude of the high-frequency-band enhancement reading sample value sequence RH equals the center value C0 is generated.

The adaptive filter 21 generates an adaptive correction reading sample value sequence RP by performing adaptive signal processing based on an LMS (least mean square) algorithm, for example, on the offset-corrected reading sample value sequence RR and supplies the adaptive correction reading sample value sequence RP to the Viterbi decoder 9 and error detection circuit 10 respectively. The adaptive filter 21 is constituted by an FIR (finite impulse response) filter, which is a variable coefficient filter, and a filter coefficient computation circuit. The filter coefficient computation circuit obtains a filter coefficient K to cause convergence to 0 of the error value indicated by the error signal E that was supplied by the error detection circuit 10 on the basis of the LMS algorithm and supplies the filter coefficient K to the FIR filter. The FIR filter generates the adaptive correction reading sample value sequence RP by performing filtering processing in correspondence with the filter coefficient K on the offset-corrected reading sample value sequence RR.

The Viterbi decoder 9 first obtains the square error value of the respective sample values in the adaptive correction reading sample value sequence RP and the estimated values Y0, Y1⁺, Y2⁺, Y3⁺, Y1⁻, Y2⁻, and Y3⁻ for each estimated value.

Further, the estimated value Y0 is the same as the center value C0 and the respective estimated values Y are related in terms of magnitude as follows:
Y3⁻<Y2⁻<Y1⁻<Y0<Y1⁺<Y2⁺<Y3⁺

Thereupon, the estimated values Y0, Y1⁺, Y2⁺, Y3⁺, Y1⁻, Y2⁻, Y3⁻ are ideal values for the reading signal that will be obtained when information reading is performed correctly from the recordable disk 2. Further, the estimated value Y1⁻ or Y1⁺ is an ideal value for the reading signal that is obtained when reading the signal segment of the shortest run length in the modulated signal recorded on the recordable disk 2. On the other hand, the estimated value Y3⁻ or Y3⁺ is an ideal value for the reading signal that is obtained when reading the signal segment of the longest run length in the modulated signal recorded on the recordable disk 2. Further, the estimated value Y0 is the center value of the amplitude of the reading signal. Thereafter, the Viterbi decoder 9 performs cumulative addition of the square error values for each of the estimated values Y as mentioned earlier and outputs a binary data sequence that corresponds to a sequence of estimated values Y for which the cumulative value is minimum as a reproduction signal.

An error detection circuit 10 first extracts a sample value with the closest value to the estimated value Y1⁺ among the estimated values Y0, Y1⁺, Y2⁺, Y3⁺, Y1⁻, Y2⁻, Y3⁻ respectively and a sample value with the closest value to the estimated value Y⁻ from the adaptive correction reading sample value sequence RP. That is, only the reading sample value obtained during reading of the signal segment of the shortest run length is extracted from the amplitude-adjusted reading sample value sequence RS. Thereafter, the error detection circuit 10 establishes, as error values, the difference between the estimated value Y1⁺ and the sample value with the closest value to the estimated value Y1⁺ and the difference between the estimated value Y1⁻ and the sample value with the closest value to the estimated value Y1⁻ and supplies the error signal E representing these values to the adaptive filter 21.

As a result of the operation of the error detection circuit 10 and adaptive filter 21, because the error between the estimated value Y1⁺ (Y1⁻) and the sample values that correspond to the modulated signal of the shortest run length in the offset-corrected reading sample value sequence RR is reduced, information data can be reproduced favorably without bringing about degradation in the decoding function of the Viterbi decoding.

Further, in the above embodiments, the AC coupling circuit 3 subjects the reading signal to a DC offset adjustment by means of the AC coupling circuit 3, adder 6, and zero crossing detection circuit 7. However, a DC offset adjustment may be implemented on the basis of the error between the reading sample values obtained when reading predetermined recording marks from the recordable disk 2 and the estimated values of the Viterbi decoder.

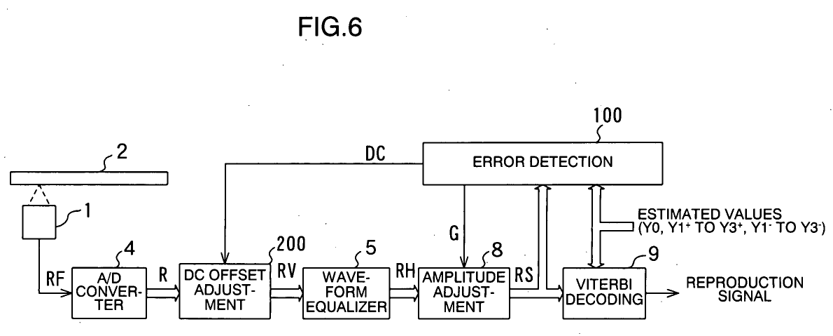

FIG. 6 shows another configuration of the recorded information reproduction apparatus that was conceived in view of this point.

In FIG. 6, the pickup 1 supplies a reading signal RF obtained by reading a modulated signal that is recorded on the recordable disk 2 to an A/D converter 4. This modulated signal is a signal obtained by performing modulation to limit the run length of various information data such as speech data, picture data, or computer data.

The A/D converter 4 samples the center-adjusted reading signal RFC with timing corresponding to a channel clock signal, converts same into the reading sample value sequence R that consists of an sequence of 8-bit sample values, for example, and supplies the reading sample value sequence R to a DC offset adjustment circuit 200. Further, the channel clock signal is a clock signal of a predetermined frequency that is phase-synchronized with the modulated signal.

The DC offset adjustment circuit 200 adds a value obtained by multiplying a predetermined correction coefficient by an offset adjustment value DC that is supplied by an error detection circuit 100 (described later) to the reading signal R and then supplies the addition result to a waveform equalizer 5 as the DC offset adjustment reading signal RV. That is, the DC offset adjustment circuit 200 supplies a signal, which is obtained by shifting the level of the whole of the signal level of the reading signal R to the extent of the value indicated by the offset adjustment value DC, to the waveform equalizer 5 as a DC offset adjustment reading signal RV.

The waveform equalizer 5 performs processing to increase the values of only the sample values corresponding to a modulated signal of a short run length in the DC offset adjustment reading signal RV, that is, high-frequency-band enhancement processing, and supplies the high-frequency-band enhancement reading sample value sequence RH thus obtained to an amplitude adjustment circuit 8.

The amplitude adjustment circuit 8 supplies an amplitude-adjusted reading sample value sequence RS obtained by adjusting the amplitude value by multiplying the amplitude adjustment value indicated by the gain adjustment signal G (described later) by the respective sample values in the high-frequency-band enhancement reading sample value sequence RH to the Viterbi decoder 9 and error detection circuit 100.

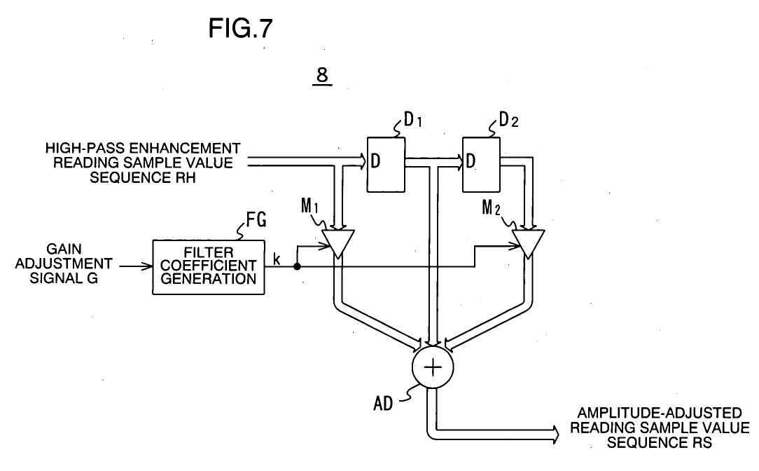

Further, a transversal filter as shown in FIG. 7 may be used as the amplitude adjustment circuit 8. In FIG. 7, the filter coefficient generation circuit FG obtains the filter coefficient k on the basis of the gain adjustment signal G and supplies the filter coefficient k to the coefficient multipliers M₁ and M₂. The coefficient multipliers M₁ supplies the multiplication result obtained by multiplying the filter coefficient k by each of the samples in the high-frequency-band enhancement reading sample value sequence RH to an adder AD. A delay circuit D₁ delays the respective samples of the high-frequency-band enhancement reading sample value sequence RH by one sampling cycle and supplies the delayed samples to a delay circuit D₂ and an adder AD. The delay circuit D₂ further delays the high-frequency-band enhancement reading sample value sequence RH supplied by the delay circuit D₁ by one sampling cycle and supplies the delayed sequence to a coefficient multiplier M₂. The coefficient multiplier M₂ supplies a multiplication result obtained by multiplying the filter coefficient k by the respective samples of the high-frequency-band enhancement reading sample value sequence RH that was delayed by two sampling cycles by the delay circuits D₁ and D₂ to the adder AD. The adder AD supplies an addition result obtained by adding the high-frequency-band enhancement reading sample values supplied by the delay circuit DI and the respective multiplication results of the coefficient multiplier M₁ and the coefficient multiplier M₂ to the Viterbi decoder 9 and error detection circuit 100 as the amplitude-adjusted reading sample value sequence RS.

The Viterbi decoder 9 first obtains the square error value of the respective sample values in the amplitude-adjusted reading sample value sequence RS and the estimated values Y0, Y1⁺, Y2⁺, Y3⁺, Y1⁻, Y2⁻, and Y3⁻ for each estimated value.

Further, the respective estimated values Y are related in terms of magnitude as follows:
Y3⁻<Y2⁻<Y1⁻<Y0<Y1⁺<Y2⁺<Y3⁺

Thereupon, the estimated values Y0, Y1⁺, Y2⁺, Y3⁺, Y1⁻, Y2⁻, Y3⁻ are ideal values for the reading signal that will be obtained when information reading is performed correctly from the recordable disk 2. Further, the estimated value Y1⁻ or Y1⁺ is an ideal value for the reading signal that is obtained when reading the signal segment of the shortest run length in the modulated signal recorded on the recordable disk 2. On the other hand, the estimated value Y3⁻ or Y3⁺ is an ideal value for the reading signal that is obtained when reading the signal segment of the longest run length in the modulated signal recorded on the recordable disk 2. Further, the estimated value Y0 is the center value of the amplitude of the reading signal.

Thereafter, the Viterbi decoder 9 performs cumulative addition of the square error values for each of the estimated values Y as mentioned earlier and outputs a binary data sequence that corresponds to a sequence of estimated values Y for which the cumulative value is minimum as a reproduction signal.

The error detection circuit 100 first extracts the maximum and minimum reading sample values that are obtained when reading predetermined recording marks from the amplitude-adjusted reading sample value sequence RS as a maximum reading sample value VUₛₐₘ and a minimum reading sample value VLₛₐₘ.

Thereafter, the error detection circuit 100 accumulates subtraction results obtained by subtracting estimated values acquired as minimum reading sample values from the extracted minimum reading sample value VLₛₐₘ while accumulating subtraction results obtained by subtracting estimated values acquired as maximum reading sample values from the extracted maximum reading sample value VUₛₐₘ. Further, these estimated values are estimated values that are used by the Viterbi decoder 9. The error detection circuit 100 supplies the result of adding the cumulative results as shown in the following equation to the DC offset adjustment circuit 200 as the offset value DC representing the level shift amount when adjusting the DC offset.
DC=Σ(VUₛₐₘ−YU_{ref})+Σ(VLₛₐₘ−YL_{ref})
where
YU_{ref}: estimated value for the maximum reading sample value VUₛₐₘ
YL_{ref}: estimated value for the minimum reading sample value VLₛₐₘ

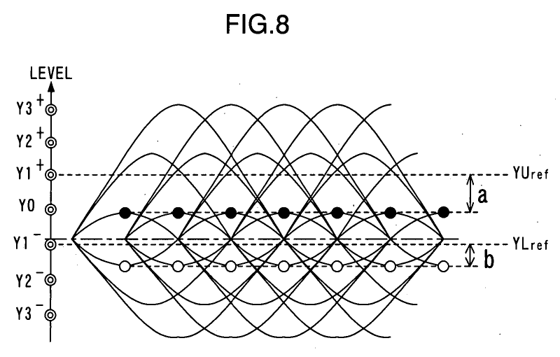

For example, when the predetermined recording marks are the recording marks of the shortest run length, the black circle signs (●) in FIG. 8 are the maximum reading sample values VUₛₐₘ and the white circle signs (ο) are the minimum reading sample values VLₛₐₘ. Furthermore, the estimated value YU_{ref} acquired as the maximum reading sample value VUₛₐₘ is the estimated value Y1⁺ and the estimated value YL_{ref} acquired as the minimum reading sample value VLₛₐₘ is the estimated value Y1⁻. Therefore, in the example shown in FIG. 8, because (VUₛₐₘ−YU_{ref}) and (VLₛₐₘ−YL_{ref}) are both negative values, the offset value DC is also a negative value. This shows that the DC level of the reading signal is lower than the predetermined level. Accordingly, the DC offset adjustment circuit 200 then performs an adjustment to shift the waveform of the reading sample value sequence R toward the positive side to the extent of the absolute value of the offset value DC.

Furthermore, the error detection circuit 100 supplies the result of adding the cumulative value of the subtraction results obtained by subtracting the estimated value YU_{ref} from the maximum reading sample value VUₛₐₘ as shown in the following equation and the cumulative value of subtraction results obtained by subtracting the minimum reading sample value VLₛₐₘ from the estimated value YL_{ref} to the amplitude adjustment circuit 8 as the gain adjustment signal G representing the adjustment amount of the amplitude adjustment.
G=Σ(VUₛₐₘ−YU_{ref})+Σ(VLₛₐₘ−YL_{ref})

For example, in an example shown in FIG. 8, (VUₛₐₘ−YU_{ref}) is a negative value and (VLₛₐₘ−YL_{ref}) is a positive value and, because
   |(VUₛₐₘ−YU_{ref}) >|(VLₛₐₘ−YL_{ref}) |, the gain adjustment signal G is also a negative value. This shows that the amplitude of the reading signal is also lower than a predetermined amplitude. Accordingly, thereupon, the amplitude adjustment circuit 8 makes an adjustment to increase the respective sample values of the high-frequency-band enhancement reading sample value sequence RH to the extent of the absolute value of the gain adjustment signal G.

The invention has been described with reference to the preferred embodiments thereof. It should be understood by those skilled in the art that a variety of alterations and modifications may be made from the embodiments described above. It is therefore contemplated that the appended claims encompass all such alterations and modifications.

This application is based on Japanese Patent Application No.2005-035710 which is hereby incorporated by reference.

What is claimed is:

1. A recorded information reproduction apparatus which obtains a binary reproduction signal from a reading sample value sequence obtained by sampling a reading signal that is read from a recording medium on which a modulated signal produced by modulating information data is recorded, comprising:
an amplitude adjustment section which obtains an amplitude-adjusted reading sample value sequence by adjusting the amplitude of the reading sample value sequence in accordance with a gain adjustment signal;
a Viterbi decoder which obtains the reproduction signal by subjecting the amplitude-adjusted reading sample value sequence to Viterbi decoding processing based on a plurality of estimated values that can be acquired as respective sample values in the reading sample value sequence; and
an error detection section for generating, as the gain adjustment signal, a difference signal representing the difference between the sample values in the amplitude-adjusted reading sample value sequence and the estimated values.

2. The recorded information reproduction apparatus according to claim 1, wherein the error detection section generates the gain adjustment signal on the basis of the difference between the estimated value closest to the estimated value indicating the center value among the respective estimated values and sample values which correspond to the modulated signal of the shortest run length in the amplitude-adjusted reading sample value sequence.

3. The recorded information reproduction apparatus according to claim 2, further comprising:
a shifting section for shifting the level of the whole of the reading signal so as to match the average value of the reading signal with the center value.

4. The recorded information reproduction apparatus according to claim 2, further comprising:
a zero crossing detection section for generating, as an offset correction value, a center sample value among three consecutive sample values when one of the two sample values at the two ends is smaller than the center value and the other sample value is larger than the center value for each of the three consecutive sample values in the reading sample value sequence; and
an offset adjustment section for performing an offset adjustment so that the center of the amplitude in the reading sample value sequence equals the center value by adding the offset correction value to the respective sample values in the reading sample value sequence.

5. A recorded information reproduction apparatus which obtains a binary reproduction signal from a reading sample value sequence obtained by sampling a reading signal which is read from a recording medium on which a modulated signal produced by modulating information data is recorded, comprising:
a multiplier which generates, as estimated values, respective multiplication results obtained by multiplying each of a plurality of initial estimated values which can be acquired as respective sample values in the reading sample value sequence by the values indicated by the gain adjustment signal;
a Viterbi decoder which obtains the reproduction signal by subjecting the reading sample value sequence to Viterbi decoding processing based on the estimated values; and
an error detection section for generating, as the gain adjustment signal, a signal representing the difference between the sample values in the reading sample value sequence and the estimated values.

6. The recorded information reproduction apparatus according to claim 5, wherein the error detection section generates the gain adjustment signal on the basis of the difference between the estimated value closest to the estimated value representing the center value among the respective estimated values and sample values which correspond to the modulated signal of the shortest run length in the reading sample value sequence.

7. The recorded information reproduction apparatus according to claim 6, further comprising:
a shifting section for shifting the level of the whole of the reading signal so as to match the average value of the reading signal with the center value.

8. The recorded information reproduction apparatus according to claim 6, further comprising:
a zero crossing detection section for generating, as an offset correction value, a center sample value among three consecutive sample values when one of the two sample values at the two ends is smaller than the center value and the other sample value is larger than the center value for each of the three consecutive sample values in the reading sample value sequence; and
an offset adjustment section for performing an offset adjustment so that the center of the amplitude in the reading sample value sequence equals the center value by adding the offset correction value to the respective sample values in the reading sample value sequence.

9. A recorded information reproduction apparatus which obtains a binary reproduction signal from a reading sample value sequence obtained by sampling a reading signal which is read from a recording medium on which a modulated signal produced by modulating information data is recorded, comprising:
an adaptive filter which obtains an adaptive correction reading sample value sequence by subjecting the reading sample value sequence to adaptive filtering processing on the basis of a filter coefficient while changing the filter coefficient to cause convergence to 0 of the error signal;
a Viterbi decoder which obtains the reproduction signal by subjecting the reading sample value sequence to Viterbi decoding processing based on a plurality of estimated values which can be acquired as respective sample values in the reading sample value sequence; and
an error detection section for generating, as the error signal, a signal representing the difference between the sample values in the reading sample value sequence and the estimated values.

10. The recorded information reproduction apparatus according to claim 9, wherein the error detection section generates the error signal on the basis of the difference between the estimated value closest to the estimated value indicating the center value among the respective estimated values and sample values which correspond to the modulated signal of the shortest run length in the amplitude-adjusted reading sample value sequence.

11. The recorded information reproduction apparatus according to claim 10, further comprising:
a shifting section for shifting the level of the whole of the reading signal so as to match the average value of the reading signal with the center value.

12. The recorded information reproduction apparatus according to claim 10, further comprising:
a zero crossing detection section for generating, as an offset correction value, a center sample value among three consecutive sample values when one of the two sample values at the two ends is smaller than the center value and the other sample value is larger than the center value for each of the three consecutive sample values in the reading sample value sequence; and
an offset adjustment section for performing an offset adjustment so that the center of the amplitude in the reading sample value sequence equals the center value by adding the offset correction value to the respective sample values in the reading sample value sequence.

13. A recorded information reproduction apparatus which obtains a binary reproduction signal from a reading sample value sequence obtained by sampling a reading signal which is read from a recording medium on which a modulated signal produced by modulating information data is recorded, comprising:
a Viterbi decoder which obtains the reproduction signal by subjecting the reading sample value sequence to Viterbi decoding processing based on a plurality of estimated values; and
a DC offset adjustment section for adjusting DC offset by entirely level-shifting the signal level of the reading signal on the basis of a differential value between a predetermined sample value in the amplitude-adjusted reading sample value sequence and the estimated values.

14. The recorded information reproduction apparatus according to claim 13, further comprising:
a gain adjustment signal generating section for generating a gain adjustment signal on the basis of the differential value; and
an amplitude adjustment section for adjusting the amplitude of the reading sample value sequence in accordance with the gain adjustment signal.
